(19) United States
(12) Patent Application Publication
(10) Pub. No.: US 2022/0374920 A1
(43) Pub. Date: Nov. 24, 2022

(54) STATISTICAL ANALYSIS METHOD FOR RESEARCH CONDUCTED AFTER PRODUCT LAUNCH

(71) Applicant: SHANGHAI MINGPIN MEDICAL DATA TECHNOLOGY CO., LTD., SHANGHAI (CN)

(72) Inventor: JUANJUAN YAO, SHANGHAI (CN)

(73) Assignee: SHANGHAI MINGPIN MEDICAL DATA TECHNOLOGY CO., LTD., SHANGHAI (CN)

(21) Appl. No.: 17/638,846

(22) PCT Filed: Aug. 26, 2020
(86) PCT No.: PCT/CN2020/111225

§ 371 Date: Aug. 13, 2022

(30) Foreign Application Priority Data
Aug. 28, 2019 (CN) 201910802852.5

(51) Int. Cl. G06Q 30/02; G06F 17/18

(52) U.S. Cl. CPC G06Q 30/0201; G06F 17/18

(57) ABSTRACT

The present invention provides a data statistical analysis method for research done after a product launch, comprising: a, collecting research data after the product launch through a plurality of research terminals, wherein the user terminals are terminals where the product is applied, and the research data comprise at least product life cycle information, intra-cycle usage information, and application feedback information; b, extracting a characteristic value set X in the research data from the research terminals; and c, extracting sales data corresponding to a time point when the research data are generated, and constructing a function S=f(X) by taking the characteristic value set as an independent variable and the sales data as a dependent variable, wherein S represents the sales data, and calculating an extremum of the function and taking the extremum as an index value for predicting the market trend.

### FIELD OF TECHNOLOGY

The present invention relates to the field of data analysis, in particular to analytical processing of correlations between product research data and market trend, and specifically to a data statistical analysis method for research conducted after a product launch.

### BACKGROUND

With the advent of the big data era, various different types of data are collected and processed, and the processing of product research data has also brought significant changes due to iterations of modern information technology. In the industrial setting, the widespread use of sensors has divided the process of product research into multiple subsidiary processes, such as collecting data elements, labeling collected big data, and cleaning, integrating, analyzing and processing the data through big data algorithms before sending them to researchers, and the researchers will use experience and professional knowledge to obtain final research conclusions based on results obtained by the big data algorithms, thereby circumventing the traditional product research and development process which entirely relies on human brain computation and judgment, and greatly accelerating the research process.

Compared with traditional research methods, the characteristics of research methods that rely on big data research and development lie in that the most important thing in a traditional research process is to rely on the experience of researchers, which is personal knowledge input, and the biggest cost of researches lies in human expenditure. For current research processes, a large amount of infrastructure is needed and they require an intelligent research system; as a result, although the research efficiency is improved, the research cost is also greatly increased.

According to traditional research theories, research is a purely input-based technical activity aiming at obtaining forward-looking research conclusions; risks also need to be considered, however, the suitability of research conclusions for market application is ranked second in most research projects, or at least not as important as obtaining forward-looking conclusions. Because the research methods have changed revolutionarily, if the assessment of research results is still focused on a single aspect, i.e., if obtaining forward-looking research conclusions is taken as the primary assessment index of research results, the ratio of research input to risk return of products will be further increased from an economic point of view.

Therefore, how to analyze and process the research data for further commercialization, i.e., to guide marketing strategies by analyzing the research data, is an inevitable trend to be in tune with the revolution of research methods in the new era, that is, effective integration of product research and market research, which are traditionally isolated from each other, will guide the research for big data analysis of product research and market research..

### SUMMARY

The technical problem to be solved by the technical solution of the present invention is how to test medical data in a standardized and rapid manner.

To solve the above technical problem, technical solutions of the present invention provide a data statistical analysis method for research conducted after a product launch, and the method includes the following steps through statistical analysis of research data after the product launch to predict a market trend:

a. collecting research data after the product launch through a plurality of research terminals, wherein the research terminals are independent of user terminals, the user terminals are terminals where the product is applied, and the research data include at least product life cycle information, intra-cycle usage information, and application feedback information;

b. extracting a characteristic value set X in the research data from the research terminals, wherein, X={x1, x2 . . . xn}, and elements forming the characteristic value set are data related to time and usage; and

c. extracting sales data corresponding to a time point when the research data are generated, and constructing a function S=f(X) by taking the characteristic value set as an independent variable and the sales data as a dependent variable, wherein S represents the sales data, and calculating an extremum of the function and taking the extremum as an index value for predicting the market trend.

Preferably, step a includes the following steps:

a1. sending, by a distribution terminal, a data limit instruction to the research terminals, wherein the data limit instruction determines an upper limit of research data to be collected by the research terminals;

a2. configuring, by a design terminal, a collection cycle of the research data; and

a3. collecting, by the research terminals, the research data according to the data limit instruction and the collection cycle.

Preferably, in step a2, the collection cycle is configured according to the following formula:

T=f(n), wherein n represents a life cycle of the product corresponding to the research data.

Preferably, the characteristic value set is composed of the collection cycle T of the research data and a duration of administration t of the product corresponding to the research data, then in step c, S=f(T, t).

Preferably, the following step is performed after step c:

d. continuing to collect the research data and extracting the characteristic value set after the function is determined, and sending, by a monitoring system, a warning signal to the distribution terminal when a stationary point of the function appears.

Preferably, the following step is performed after step d:

e. adjusting, by the distribution terminal, the data limit instruction and/or the collection cycle.

Preferably, step e includes the following steps:

e1. judging whether the stationary point belongs to any one of a saddle point, a maximum value, or a minimum value of the function; and

e2. increasing the data limit instruction and increasing the collection cycle if the stationary point is a saddle point, decreasing the data limit instruction and increasing the collection cycle if the stationary point is a maximum value, and increasing the data limit instruction and decreasing the collection cycle if the stationary point is a minimum value.

Preferably, repeat step c if the number of times that the distribution terminal adjusts the data limit instruction and/or the collection cycle exceeds a threshold, wherein the threshold is set by the monitoring system.

Preferably, if a collection method required by the research terminals is not compatible with the data limit instruction or the collection cycle, this research terminal may not upload research data.

In the present invention, a function model is constructed using numerical values related to time and quantity in the research data as independent variables and the market trend as a dependent variable, and the function model is continuously improved through accumulating the research data to predict the market trend. Further, in the present invention, the function model is also indirectly optimized through adjusting the data limit instruction and/or the collection cycle, in order to predict the market trend more accurately.

### BRIEF DESCRIPTION OF THE DRAWINGS

Other characteristics, objectives and advantages of the present invention will become more apparent through reading the detailed description of non-limiting embodiments made with reference to the following accompanying drawings:

FIG. 1 is a flow chart of a data statistical analysis method for research done after a product launch in a specific execution mode of the present invention;

FIG. 2 is a flow chart of another data statistical analysis method for research done after a product launch in a first embodiment of the present invention;

FIG. 3 is a flow chart of a data statistical analysis method for research done after a product launch providing warning information in a second embodiment of the present invention;

FIG. 4 is a flow chart of a data statistical analysis method for research done after launch of an adjustable product in a third embodiment of the present invention; and

FIG. 5 is a flow chart of a data statistical analysis method for research done after launch of an accurately-regulated product in a fourth embodiment of the present invention.

### DETAILED DESCRIPTION

In order to make the technical solution of the present invention more clearly represented, the present invention will be further described below in combination with accompanying drawings.

Those skilled in the art may understand that the research data formed through the research done after a product launch are fundamentally different from the traditional research data of products, and are also different from the market research data. Traditional product research and development is mostly the research and development of new products or research of technology iteration, therefore, the data focused on or collected during the research and development process are data obtained based on forward-looking prediction; of course, the forward-looking prediction may be obtained based on market research, or based on technical analysis of competing products or defects of original products; however, in any case, the forward-looking prediction must be an idealized hypothetical model suitable for repeated laboratory validation. Afterwards, research and development personnel will repeatedly implement research and development activities with a goal of realizing the hypothetical model based on the research method in a statistical sense, and accordingly, data formed in this case are semi-artificial data that are separated from the real world with a goal of conforming to a preset hypothetical model. Such data are statistically significant from a perspective of big data analysis. However, due to the addition of a large number of artificially set factors in its collection process, for example, experimental conditions, material selection, selection of enrolled objects and the like, the probability of consistency between its data and the real world is greatly reduced; therefore, this explains why the existing research and development activities are mostly pure cost for enterprises and cannot be commercialized, and the reason lies in that the market itself is a real world, and the most important thing about an analysis of the market trend is to be closely compatible with the real world.

Further, market research data are different from traditional research data in that they are from the real world, but the source objects of market research data are users after the direct application of products, so professionalism of data is insufficient and only has statistical significance. If statistical analysis of big data is permissible, but if the big data are taken as basic data, the development and research of artificial intelligence systems for predicting the market trend, which lacks the most core data formation logic, cannot be used as effective materials for machine learning.

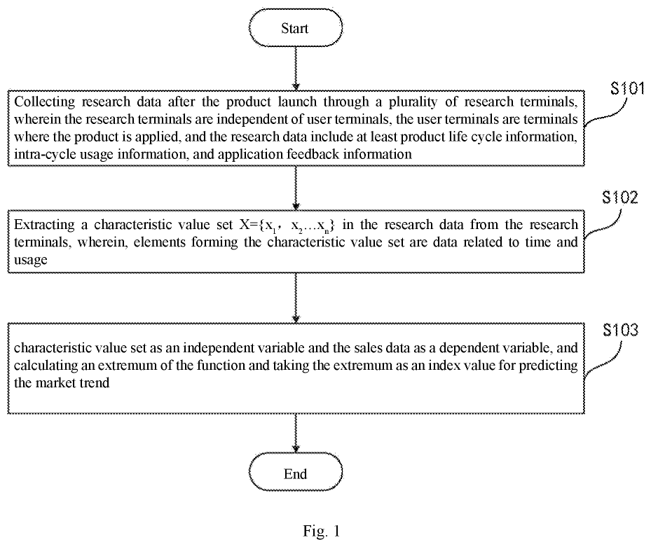

In summary, an objective of the present invention is to closely integrate data formed in research and development activities and the market through an innovative data analysis method, to give full play to the potential of data, improve effectiveness of research and development activities of enterprises, and increase the enthusiasm of enterprises in performing research and development activities. FIG. 1 shows a data statistical analysis method for research done after a product launch according to one specific embodiment of the present invention, and the method includes the following steps:

Firstly perform step S101, to collect research data after the product launch through a plurality of research terminals, the research terminals are independent of user terminals, the user terminals are terminals where the product is applied, and the research data include at least product life cycle information, intra-cycle usage information and application feedback information. Specifically, the research data are different from market research data and a data model is designed for the purpose of research and development, therefore, the data include at least quantitative and qualitative information such as life cycle information, intra-cycle usage information and application feedback information of products. Those skilled in the art may understand that the data come from an independent research terminal of a third party, rather than a direct user of the product, so that the uploading of sentimentalized data which affects the objectivity of data can be maximally avoided, meanwhile, the research terminals may also process the information fed back by a user in a specialized method that facilitates research progress, i.e., the research data are data from real-world applications, and are data that have been structuralized by the research terminals. More specifically, in this step, the quality of data is controlled by limiting the source terminal of the data and the label type of information, and the data are also distinguished from traditional pure research data and pure market research data, wherein the product life cycle information refers to a standardized application cycle as disclosed in a product manual, or can be an application cycle adjusted by the user according to his own situation; for example, a complete application cycle of a product is 7 days, the user actually uses it for 3 cycles, then the product life cycle information is 21 days; the intra-cycle usage information refers to unit usage of a product, for example, the weight of the unit product is 5 mg, a single cycle takes 10 units of usage, and if the user actually uses the product for 3 cycles, then the product usage of the user is 150 mg in total; the application feedback information is positive or negative feedback information edited and generated by the research terminals according to the use of the user terminals, and, generally, the application feedback information is mainly used for research and development and are not necessarily relevant to the implementation of the present invention. In a preferred embodiment, the application feedback information may be labeled, different adjustment coefficients are configured for different labels, and accordingly, the research terminals obtain product life cycle information and intra-cycle usage information through the following method:

the product life cycle information is obtained by multiplying an original product life cycle with the adjustment coefficient, and the intra-cycle usage information is obtained by multiplying original intra-cycle usage information by the adjustment coefficient, wherein the original product life cycle is an actual life cycle of the user terminals, and the original intra-cycle usage information is the total usage of products used in the actual life cycle of the user terminals.

Further, perform step S102, to extract a characteristic value set X in the research data of the research terminals, wherein X={x1, x2 . . . xn}, and the elements forming the characteristic value set are data related to time and usage. Specifically, with reference to step S101, the research data contain product life cycle information and intra-cycle usage information, and those skilled in the art can understand that, the product life cycle information is preferably expressed in data in a duration format, such as days, months, years, etc.; and in one exemplary variation, the expression may also be customized, such as in a unit of “treatment course”, under which case, different treatment courses may be categorized and edited by configuring an underlying database, which is conducive to simplification of the data in the application layer; the intra-cycle usage information is preferably expressed in data in weight units, such as micrograms, milligrams, grams, etc. Accordingly, the intra-cycle usage information may be calculated in two ways, in one way, calculation is directly performed according to weights of products, in another way, calculation is performed according to effective substance in products, For research purposes, the latter calculation method is more appropriate; for the present invention, the calculation is preferably performed according to weights of products.

Further, perform step S103, to extract sales data corresponding to a time point when the research data are generated, and construct a function S=f(X) by taking the characteristic value set as an independent variable and the sales data as a dependent variable, and calculate an extremum of the function and take the extremum as an index value for predicting the market trend. Those skilled in the art can understand that, with reference to step S102, the characteristic value is data related to time and usage, that is, the characteristic value contains more than two types of information; it can be seen from the function in this step that the function of the market trend is a multivariable function, with reference to the technical problems to be solved in the present invention, the purpose of having multiple variables in the function is to effectively integrate traditionally isolated product research and market research, and the key to such integration is how to find an optimal solution after the whole process from data collection to data operation is finished; that is, not only the requirement of research and development need to be satisfied, but also the requirement of market prediction, and the multivariate function is able to satisfy the dual requirements of research and development and marketing through synchronous assignment of data resources.

Further, the function of this step is formed based on previously accumulated research data and sales data; the collection of research data is understood with reference to steps S101 and S102; specifically, the production time and characteristic value of the research data are related to step S103,and those skilled in the art may understand that the research data are collected by the research terminals, while the generation time of the research data and the collection time of the research terminals are not necessarily the same, i.e., the research data require the research terminals to be marked with corresponding generation timestamps during the collection process, the generation timestamp is the time point at which the research data are generated, and the sales data corresponding to the time point may be used as a dependent variable of the function, and those skilled in the art may understand that in practical applications, the date format of the time point may be YYMMDD, YYMM, or YY, while the sales data may be from the same database, or may be from different databases, that is, the format of the generation time of the sales data may be the same as or different from the format of the generation time of the research data, and the “corresponding time point” defined in this step means overlapping time between the generation time of the sales data and the generation time of the research data; for example, if the generation time of the sales data is October 2018 while the generation time of the research data is Oct. 5, 2018, then the sales data may be used as a dependent variable; still with the present embodiment as an example, if no sales data exist in October 2018, it means that the corresponding characteristic value of the research data generated at the time point does not have a corresponding dependent variable (i.e., the sales data), and for the present invention, even if research data are collected at the time point, the research data are redundant data. Therefore, in order to improve the utilization rate of the research data, the sales data involved in the present invention should be collected continuously on a regular basis, i.e., the collection schedule of the sales data should be the same as or similar to the collection schedule of the research data, so as to ensure that the corresponding sales data may be extracted at the time point corresponding to each research data. More specifically, the sales data may be an amount or a shipment, and accordingly, the units of measurement of the sales data are also different, but this does not affect the implementation of the present invention.

Those skilled in the art may understand that in step S103, the specific operation rules of the function are not defined, and the functions formed by different characteristic values and different sales data are also different; accordingly, the extremums corresponding to different functions are also different, and in the present invention, the market trend is quantitatively expressed through the extremum of the function, which is a solution not used in the prior art. Specifically, with the accumulation of the research data and sales data, the function will change, and accordingly, the extremum of the function will change, that is, the index value used to express the market trend will also change, at this time, that is, the purpose of the present invention is achieved, thereby changing the traditional method of predicting the market trend relying only on sales data. More specifically, the extremum of the function may be possibly a maximum value or a minimum value, representing the peak or the lowest valley of the development of the market trend respectively. For practical applications, the sales data are usually not controllable, i.e., the sales data depend on the objective behavior of consumers, and even if the market trend is predicted, the usual method is to adjust the sales strategy, but the adjustment of the sales strategy does not necessarily bring about changes in the market, because the adjustment still depends on objective behaviors of consumers. The technical solution adopted in the present invention is characterized by the fact that the research data may be controllable by a merchant, and the merchant may indirectly control the characteristic value set by adjusting the collection method of the research data, i.e., the independent variable used to generate the function is adjusted, to finally achieve a more accurate market trend prediction and adjustment, and at the same time, the market trend may also be influenced by adjusting the collection method of the research data, which will be described in details in subsequent embodiments of the present invention.

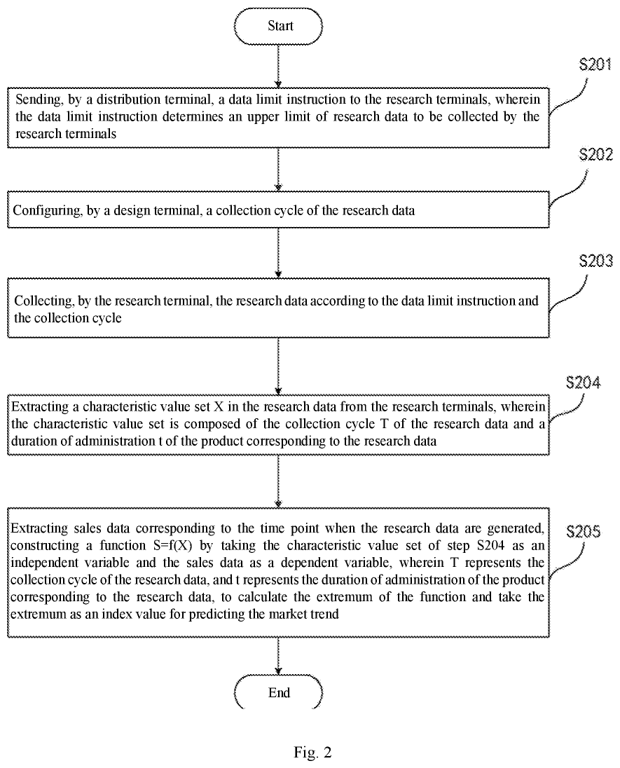

As a first embodiment of the present invention, FIG. 2 shows a flow chart of another data statistical analysis method for research done after a product launch, including the following steps:

first perform step S201, wherein the distribution terminal sends a data limit instruction to the research terminals, and the data limit instruction determines an upper limit of research data to be collected by the research terminals. Specifically, the data limit instruction defines the research data in multiple ways, for example, the data limit instruction may define the amount of research data, the research data may be considered as one case of research data after designed contents of the research data are completely collected, then the data limit instruction is defined with a case as a unit; for another example, the total amount of the research data may be defined, the usual units of measurement of data, such as bytes, kilobytes, megabytes, bits, kilobits, megabits and the like are taken as the units for calculating the total amount. At this time, when the total amount of data collected by the research data exceeds a preset data amount threshold, the research terminals stop collecting data. Those skilled in the art may understand that, through the defining in this step, a broad spectrum of data sources may be available, thereby avoiding getting a majority of the data from a fixed subset of research terminals.

Further, perform step S202, wherein the design terminal configures a collection cycle of the research data. Specifically, the design terminal is specifically responsible for the design of collection format, content, path and method of the research data, while the collection cycle in this step belongs to the collection method of the research data, accordingly, the data limit instruction actually also belongs to the collection method of the research data. More specifically, the collection cycle of the research data influences the generation frequency of the research data.

As a specific implementation mode of step S202, the collection cycle is configured according to the following formula T=f(n), wherein n represents a life cycle of a product corresponding to the research data; in this step, the expression of the formula is not specifically defined. Those skilled in the art may understand that, the advantage of configuring a fixed coefficient lies in that the collection cycle may not be necessarily the same as the product life cycle; preferably, one fixed coefficient may be configured, then T=f(n)=δ×n; more preferably, specific numerical value of the fixed coefficient may be set by the research terminals, thereby providing more freedom of collection to the research terminals.

Further, perform step S203, wherein the research terminals collect the research data according to the data limit instruction and the collection cycle. Those skilled in the art may understand that, the collection method of the research data is defined in this step. Specifically, in this step, the collection method is defined in two aspects, one is the total data amount, and the other is the collection cycle, in order to collect data on time according to quantity and conforming to the objective of the present invention. More specifically, the information content of traditional research data is for the object of research and does not specifically limit the collection method of the research data, and therefore the collection method is not integrated as part of the research data. In the present embodiment, the data limit instruction and the collection cycle are integrated into the research data as two items of information to prepare for subsequent steps.

Further, perform step S204, to extract a characteristic value set X in the research data from the research terminals, wherein the characteristic value set is composed of the collection cycle T of the research data and a duration of administration t of the product corresponding to the research data. In combination with description of S102, in this step, only the characteristic value set is specifically defined, that is, the characteristic value set contains two elements, and those skilled in the art may understand that, the duration of administration of the product is contained in the research data as an information content of the general research data, for assisting in measuring effect of the product; however, in the present invention, the duration of administration is also used for analysis of the market trend.

Further, perform step S205, to extract sales data corresponding to a time point when the research data are generated, and construct a function S=f(X)=f(T, t) by taking the characteristic value set of step S204 as an independent variable and the sales data as a dependent variable, wherein T represents the collection cycle of the research data, and t represents the duration of administration of the product corresponding to the research data, to calculate the extremum of the function and take the extremum as an index value for predicting the market trend. Those skilled in the art may understand this step with reference to step S103.

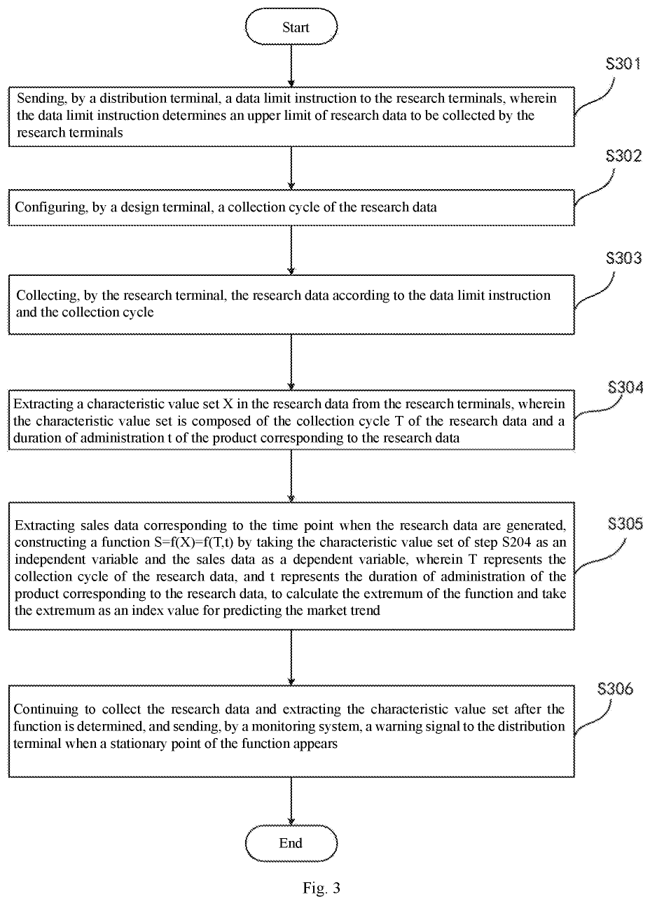

As a second embodiment of the present invention, FIG. 3 shows a flow chart of a data statistical analysis method for research done after a product launch providing warning information, including the following steps:

first, perform step S301, wherein the distribution terminal sends a data limit instruction to the research terminals, and the data limit instruction determines an upper limit of research data to be collected by the research terminals. Those skilled in the art may understand this step with reference to step S201.

Further, perform step S302, wherein a design terminal configures a collection cycle of the research data. Those skilled in the art may understand this step with reference to step S202.

Further, perform step S303, wherein the research terminals collect the research data according to the data limit instruction and the collection cycle. Those skilled in the art may understand this step with reference to step S203.

Further, perform step S304, to extract a characteristic value set X in the research data from the research terminals, wherein the characteristic value set is composed of the collection cycle T of the research data and a duration of administration t of the product corresponding to the research data. Those skilled in the art may understand this step with reference to step S204.

Further, perform step S305, to extract sales data corresponding to a time point when the research data are generated, and construct a function S=f(X)=f(T, t) by taking the characteristic value set of step S304 as an independent variable and the sales data as a dependent variable, wherein T represents the collection cycle of the research data, and t represents the duration of administration of the product corresponding to the research data, to calculate the extremum of the function and take the extremum as an index value for predicting the market trend. Those skilled in the art may understand this step with reference to step S205.

Further, perform step S306, to continue to collect the research data and extract the characteristic value set after the function is determined, and send, by a monitoring system, a warning signal to the distribution terminal when a stationary point of the function appears. Those skilled in the art may understand that, when the stationary point appears, it means that the value of the function stops increasing or begins to decrease, that is, the appearance of the stationary point represents the appearance of a critical point, the object to be achieved in the present invention is to find out the market trend through an analysis of the research data, while prediction in advance of the critical point is the first object of the present invention, during actual application, the warning when the critical point appears is more specific and practical. Specifically, when a stationary point appears, it is not necessarily a global extreme point of the function, but often shows a local extreme, or called a periodical maximum value or minimum value, which is more important in the control of the market trend, that is, we can prevent an irreversible damage of the market trend through periodical warning. More specifically, the implementation of this step is based on the premise that the function has been determined, i.e., the research data at this time are newly collected and are not the research data used to generate the function, and after the newly collected research data are obtained, a new characteristic value set is then obtained; and accordingly, with the new characteristic value set as an independent variable, the corresponding dependent variable, i.e., the sales data, may be obtained, and the sales data are also not the historical sales data used to generate the function, but the sales data predicted according to the newly collected research data; and along with the advancement of the collection progress of the research data, when the characteristic value set corresponding to a certain set of research data is coincided with the point at which the first-order partial derivative of the function is zero, the monitoring system sends a warning signal to the distribution terminal.

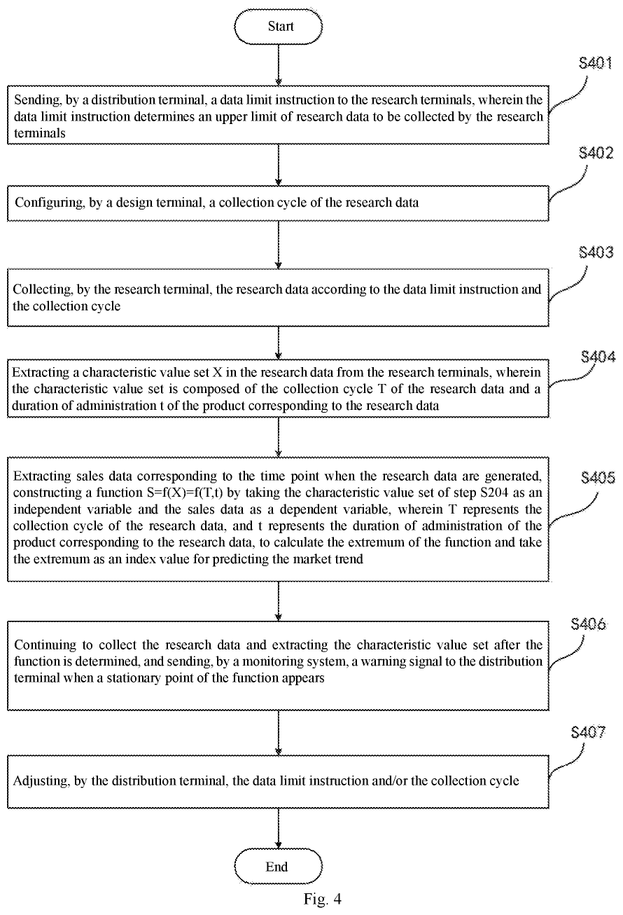

As a third embodiment of the present invention, FIG. 4 shows a flow chart of a data statistical analysis method for research done after launch of an adjustable product, including the following steps:

firstly perform step S401, wherein the distribution terminal sends a data limit instruction to the research terminals, and the data limit instruction determines an upper limit of research data to be collected by the research terminals. Those skilled in the art may understand this step with reference to step S201.

Further, perform step S402, wherein a design terminal configures a collection cycle of the research data. Those skilled in the art may understand this step with reference to step S202.

Further, perform step S403, wherein the research terminals collect the research data according to the data limit instruction and the collection cycle. Those skilled in the art may understand this step with reference to step S203.

Further, perform step S404, to extract a characteristic value set X in the research data from the research terminals, wherein the characteristic value set is composed of the collection cycle T of the research data and a duration of administration t of the product corresponding to the research data. Those skilled in the art may understand this step with reference to step S204.

Further, perform step S405, to extract sales data corresponding to a time point when the research data are generated, and construct a function S=f(X)=f(T, t) by taking the characteristic value set of step S404 as an independent variable and the sales data as a dependent variable, wherein T represents the collection cycle of the research data, and t represents the duration of administration of the product corresponding to the research data, to calculate the extremum of the function and take the extremum as an index value for predicting the market trend. Those skilled in the art may understand this step with reference to step S205.

Further, perform step S406, to continue to collect the research data and extract the characteristic value set after the function is determined, and send, by a monitoring system, a warning signal to the distribution terminal when a stationary point of the function appears. Those skilled in the art may understand this step with reference to step S306.

Further, perform step S407, wherein the distribution terminal adjusts the data limit instruction and/or the collection cycle. Specifically, when the distribution terminal receives the warning signal, the distribution terminal do not directly suspend the distribution of the research data index as usual, that is, the research terminals will usually temporarily stop collection of the research data; while in step S407 of this embodiment, the characteristic value set is indirectly controlled through adjusting the collection method of the research data, that is, the independent variable configured to generate the function is adjusted, thereby ultimately achieving more accurate market trend prediction and adjustment, and at the same time, the market trend is influenced also through adjusting the collection method of the research data. Those skilled in the art may understand that, the products to which the present invention applies are mostly research-driven products, i.e., the sales of the products depend mainly on their underlying techniques, rather than market strategies and sales strategies, and the collection method of the research data will influence the collection behaviors of the research terminals, which will indirectly play a role in the technical advancement and professional influence of the products, and eventually be reflected in sales, which is more accurate and sustainable than the traditional way of analyzing the sales data with market share, price trends, and changes in consumer groups as the main variables.

In a more preferred embodiment, a threshold may be set, and when the times of adjusting the data limit instruction and/or the collection cycle exceed the threshold, step S405 is repeated, i.e., the function is regenerated to more accurately express the prediction of the market trend.

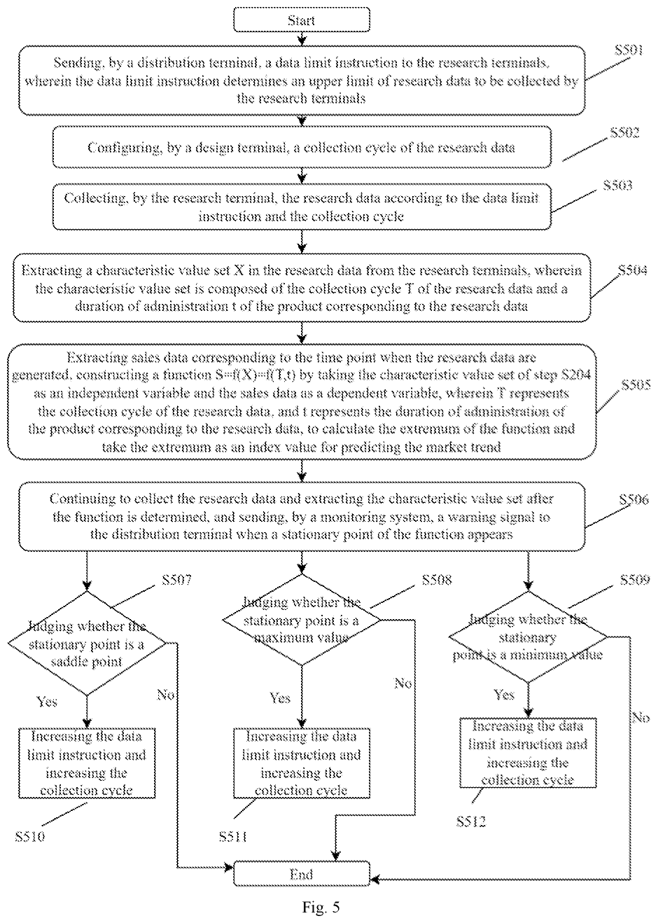

As a fourth embodiment of the present invention, FIG. 5 shows a flow chart of a data statistical analysis method for research done after launch of an accurately-regulated product, including the following steps:

firstly perform step S501, wherein the distribution terminal sends a data limit instruction to the research terminals, and the data limit instruction determines an upper limit of research data to be collected by the research terminals. Those skilled in the art may understand this step with reference to step S201.

Further, perform step S502, wherein a design terminal configures a collection cycle of the research data. Those skilled in the art may understand this step with reference to step S202.

Further, perform step S503, wherein the research terminals collect the research data according to the data limit instruction and the collection cycle. Those skilled in the art may understand this step with reference to step S203.

Further, perform step S504, to extract a characteristic value set X in the research data from the research terminals, wherein the characteristic value set is composed of the collection cycle T of the research data and a duration of administration t of the product corresponding to the research data. Those skilled in the art may understand this step with reference to step S204.

Further, perform step S505, to extract sales data corresponding to a time point when the research data are generated, and construct a function S=f(X)=f(T, t) by taking the characteristic value set of step S504 as an independent variable and the sales data as a dependent variable, wherein T represents the collection cycle of the research data, and t represents the duration of administration of the product corresponding to the research data, to calculate the extremum of the function and take the extremum as an index value for predicting the market trend.

Further, perform step S506, to continue to collect the research data and extract the characteristic value set after the function is determined, and send, by a monitoring system, a warning signal to the distribution terminal when a stationary point of the function appears. Those skilled in the art may understand this step with reference to step S306.

Further, perform step S507, to judge whether the stationary point belongs to a saddle point; perform step S508, to judge whether the stationary point belongs to a maximum value; and perform step S509, to judge whether the stationary point belongs to a minimum value. Those skilled in the art may understand that, after the function is determined, the saddle point, the maximum value and the minimum value may be determined. Of course, the function possibly only has one or several of the saddle point, the maximum value and the minimum value, but this does not influence implementation of the present invention. Specifically, along with advancement of the collection process of the research data, when the characteristic value set corresponding to a certain set of research data is determined, this step is used to judge whether the point corresponding to the characteristic value set is coincided with any of the saddle point, the maximum value, or the minimum value of the function. More specifically, steps S507 to S509 shown in FIG. 4 are performed synchronously, as a variation, steps S507 to S509 may also be performed sequentially, and the order is not limited.

Further, if the stationary point is a saddle point, then perform step S510 to increase the data limit instruction and increase the collection cycle; if the stationary point is a maximum value, then perform step S511 to decrease the data limit instruction and increase the collection cycle; and if the stationary point is a minimum value, then perform step S512 to increase the data limit instruction and decrease the collection cycle. Those skilled in the art may understand that, the content of this paragraph is used to guide an actual adjustment solution, i.e., how to influence the market trend by adjusting the collection method, because the research data will be necessarily influenced through adjusting the data limit instruction and the collection cycle, for example, if a saddle point appears, the appearance of a maximum value may be avoided through adjustment, and for another example, if a maximum value appears, the appearance of a minimum value may also be avoided through adjustment.

As a variation, if the collection method of certain research terminals is not compatible with the data limit instruction or the collection cycle, these research terminal will not be able to upload research data. Specifically, after the distribution terminal adjusts the data limit instruction or the collection cycle, the research terminals can't adapt accordingly, that is, the research terminals are still accustomed to traditional collection methods. In the present embodiment, the form in which a system sets a collection rejection instruction avoids the research data uploaded by the research terminals from being incompatible with new requirements, and meanwhile, the collection behaviors of the research terminals are further controlled, which in turn indirectly affects sales of products.

Specific embodiments of the present invention have been described above. It should be understood that the present invention is not limited to the above specific execution modes, and those skilled in the art may make various variations or modifications within the scope of the claims, which will not affect essential contents of the present invention.

1. A data statistical analysis method for research conducted after a product launch, wherein the method comprises the following steps to predict a market trend:
a. collecting research data after the product launch through a plurality of research terminals, wherein the research terminals are independent of user terminals, the user terminals are terminals where the product is applied, and the research data comprise at least product life cycle information, intra-cycle usage information, and application feedback information;
b. extracting a characteristic value set X in the research data from the research terminals, wherein, X={X1, X2 . . . Xn}, and elements forming the characteristic value set are data related to time and usage; and
c. extracting sales data corresponding to a time point when the research data are generated, and constructing a function S=f(X) by taking the characteristic value set as an independent variable and the sales data as a dependent variable, wherein S represents the sales data, and calculating an extremum of the function and taking the extremum as an index value for predicting the market trend.

2. The data statistical analysis method according to claim 1, wherein step a further comprises the following steps:
a1. sending, by a distribution terminal, a data limit instruction to the research terminals, wherein the data limit instruction determines an upper limit of research data to be collected by the research terminals;
a2. configuring, by a design terminal, a collection cycle of the research data; and
a3. collecting, by the research terminals, the research data according to the data limit instruction and the collection cycle.

3. The data statistical analysis method according to claim 2, wherein in step a2, the collection cycle is configured according to the following formula:
T=f(n), wherein, n represents a life cycle of the product corresponding to the research data.

4. The data statistical analysis method according to claim 3, wherein the characteristic value set is composed of the collection cycle T of the research data and a duration of administration t of the product corresponding to the research data, then in step c, S=f(T, t).

5. The data statistical analysis method according to claim 3, wherein the following step is performed after step c:
d. continuing to collect the research data and extracting the characteristic value set after the function is determined, and sending, by a monitoring system, a warning signal to the distribution terminal when a stationary point of the function appears.

6. The data statistical analysis method according to claim 5, wherein the following step is performed after step d:
e. adjusting, by the distribution terminal, the data limit instruction and/or the collection cycle.

7. The data statistical analysis method according to claim 6, wherein step e further comprises the following steps:
e1. judging whether the stationary point belongs to any one of a saddle point, a maximum value, or a minimum value of the function; and
e2. increasing the data limit instruction and increasing the collection cycle if the stationary point is a saddle point, decreasing the data limit instruction and increasing the collection cycle if the stationary point is a maximum value, and increasing the data limit instruction and decreasing the collection cycle if the stationary point is a minimum value.

8. The data statistical analysis method according to claim 6, wherein the method further comprises: repeating step c if the number of times that the distribution terminal adjusts the data limit instruction and/or the collection cycle exceeds a threshold, wherein the threshold is set by the monitoring system.

9. The data statistical analysis method according to claim 1, wherein if a collection method required by one of the research terminals is not compatible with the data limit instruction or the collection cycle, this research terminal may not upload research data.
